(19) United States
(12) Patent Application Publication
(10) Pub. No.: US 2016/0253374 A1
(43) Pub. Date: Sep. 1, 2016

(54) DATA FILE WRITING METHOD AND SYSTEM, AND DATA FILE READING METHOD AND SYSTEM

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventors: Bing DAI, Beijing (CN); Chao ZHU, Beijing (CN); Chao WANG, Beijing (CN)

(73) Assignees: Guangdong Alpha Animation & Culture Co., Ltd, Shantou (CN); Guangdong Auldey Animation & Toy Co., Ltd., Guangzhou (CN); Guangzhou Alpha Culture Communication Co.,Ltd, Guangzhou (CN)

(21) Appl. No.: 15/029,547

(22) PCT Filed: Sep. 12, 2014
(86) PCT No.: PCT/CN2014/086441

§ 371 Date: Apr. 14, 2016

(30) Foreign Application Priority Data
Oct. 16, 2013 (CN) 201310484997.8

(51) Int. Cl. G06F 17/30

(52) U.S. Cl. CPC G06F 17/30371; G06F 17/30312

(57) ABSTRACT

The present invention discloses a data file writing method and system, and a data file reading method and system. The data file writing method is used for writing to-be-written data to a data file, and comprises: obtaining one or more piece of to-be-written data; setting a first character string; taking each piece of to-be-written data as a unit and adding the first character string in each unit, and locating the first character string at the front end of each unit for identifying each unit; and writing each unit to the data file. By the present invention, even if it occurs in the data file that a part of data is damaged, undamaged data in the data file can still be searched for to be read.

### FIELD OF THE INVENTION

The invention relates to the field of computer data processing, and in particular, to a data file writing method and system, and a data file reading method and system.

### BACKGROUND OF THE INVENTION

In a computer system, such as a storage system, a scenario often occurs in which multiple processes are reading/writing a data file. For example, one process writes data to a file according to a certain protocol format, and then another process reads this file and parses the content of the file according to the protocol format.

In most cases, it is no problem to do so. However, if a computer is down accidently, resulting in that a process terminates halfway when writing certain data, which will lead to damage of a data file, a problem will occur when a reading process parses its content according to a previously agreed protocol, thereby resulting in that all subsequent data can not be read.

For example, in a message queue system, there is a function of sending a message asynchronously. When sending a message, a message producer invokes an asynchronously sending interface to send it. The asynchronously sending interface directly writes the message to a local file, which forms a message file. Meanwhile, the machine where the message producer is located will launch a daemon process to read the message file in real time and forward the content therein to a broker. An architecture diagram is as shown in FIG. 1.

A format in which the message producer writes to the message file is as follows: each message is successively added to the end of the file, wherein each message contains a message length of 4 bytes, which is followed by the content of the message (the length of the content of the message is consistent with the length reflected by the message length of 4 bytes). After the message producer sends 3 messages, the format of the message file is as shown in FIG. 2, the contents in the 3 messages respectively are the message content 1 with a length of 68 bytes, the message content 2 with a length of 20 bytes and the message content 3 with a length of 53 bytes.

If when the message producer sends the third message, only half of the message content 3 is written and the machine is down suddenly, then the data writing is incomplete. After the machine is launched, if the message producer continues to send a message, then after sending of a fourth message is finished, the format of the message file is as shown in FIG. 3.

Since the message content 3 is incomplete, after the fourth message is written, when reading and then parsing the content of the file, another process will erroneously take a part of the fourth message as content of the third message, and then the 4 bytes header (message length) of the fourth message will also be inaccurate, which will in turn result in that the subsequent content will not be parsed correctly.

To avoid the occurrence of the above-mentioned problem, a solution is to add an index file, in which the starting position of each message in the message file and its message length are specified. Each time the message producer sends a message, it first queries the index file about the position where the current message should be written, then updates the message file, and finally updates the index file.

Accordingly, each time a reading process reads a message, it first queries about the position of the message and its length in the index file, and then locates the corresponding position of the message file.

If the machine is down suddenly when the message file is updated, the index file will not be updated, thus the message is invisible to the reading process, and therefore disorder of the message file will not be caused.

However, the scheme of employing an index file also has the following deficiencies.

1. The operational complexity is increased.

Since both the writing process and reading process need to involve operations of two files at the same time, it is troublesome. For each time, the writing process needs to first read the index file, then write the data file, then continue to update the index file, . . . ; and the reading process needs to first read the index file, then read the data file, then continue to read the index file, . . . .

2. The system performance is decreased.

Since two files are operated at the same time, this will cause a loss to the system performance. First, the content that is read and written is more than before. Second, when reading/writing multiple files is involved, it is not strict sequential reading/writing of a disk, which poses a certain impact on the system performance.

Therefore, the technical problem that the invention needs to solve lies in that after a part of the data of a data file is damaged, how to correctly read the undamaged data of the entire file, and make the procedure of reading/writing the data file does not involve files other than the data file, so as to reduce the operational complexity and avoid an unnecessary loss of the system performance.

### SUMMARY OF THE INVENTION

In view of the above problem, the invention is proposed to provide a data file writing method and system, and a data file reading method and system, which can overcome the above problem or at least partly solve the above problem.

According to an aspect of the invention, there is provided a data file writing method for writing to-be-written data to a data file, comprising: obtaining one or more piece of to-be-written data; setting a first character string; taking each piece of to-be-written data as a unit and adding the first character string in each unit, and locating the first character string at the front end of each unit for identifying each unit; and writing each unit to the data file.

According to another aspect of the invention, there is provided a data file writing system for writing to-be-written data to a data file, comprising: a to-be-written data obtaining module configured to obtain one or more piece of to-be-written data; a first character string setting module configured to set a first character string; a first character string adding module configured to take each piece of to-be-written data as a unit and add the first character string in each unit, and locate the first character string at the front end of each unit for identifying each unit; and a unit writing module configured to write each unit to the data file.

According to the data file writing method and system of the present invention, in the procedure of writing a data file, each piece of to-be-written data is combined with a first character string and taken as a unit, the first character string is located at the front end of the unit and functions to identify each unit, so as to ensure that in a procedure of reading the data file, even if a part of the units in the data file is damaged, other unit can still be found by searching for the first character string, and if the found unit is not damaged, the data therein can be read correctly, thereby solving the technical problem of how to read undamaged data in the data file on the basis of not involving other files, wherein as compared to the conventional scheme, only writing one file is involved, the written content becomes less, and writing a single file is easier, which benefits the improvement of the writing performance, and compared with increasing an index file, increasing a first character string is much easier, which also reduces the possibility of making errors.

According to another aspect of the invention, there is provided a data file reading method for reading to-be-read data from a data file, the data file comprises one or more unit, each unit having a first character string at the front end, each unit further having a piece of to-be-read data, and the method comprising: searching the data file for the first character string, wherein if one or more first character string is found, it indicates that a unit where the one or more first character string is located is found; and reading to-be-read data in the unit according to a predetermined rule.

According to another aspect of the invention, there is provided a data file reading system for reading to-be-read data from a data file, the data file comprises one or more unit, each unit having a first character string at the front end, each unit further having a piece of to-be-read data, and the system comprises: a first character string searching module configured to search the data file for the first character string, wherein if one or more first character string is found, it indicates that a unit where the one or more first character string is located is found; and a to-be-read data reading module configured to read to-be-read data in the unit according to a predetermined rule.

According to the data file reading method and system of the present invention, since each piece of to-be-read data in a data file is combined with a first character string and taken as a unit, and the first character string is located at the front end of the unit and can function to identify each unit, in the procedure of reading the data file, even if a part of the units in the data file is damaged, other unit can still be found by searching for the first character string, and if the found unit is not damaged, the data therein can be read correctly, thereby solving the technical problem of how to read undamaged data in the data file on the basis of not involving other file, wherein as compared to the conventional scheme, only reading one file is involved, the content that needs to be read becomes less, and reading a single file is easier, which benefits the improvement of the reading performance.

According to yet another aspect of the invention, there is provided a computer program comprising a computer readable code which causes a computing device to perform any of the data file writing method and/or the data file reading method described above, when said computer readable code is running on the computing device.

According to still another aspect of the invention, there is provided a computer readable medium storing therein the computer program as described above.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a working procedure of a message queue system;

FIG. 2 shows a structure of a message file;

FIG. 3 shows another structure of a message file;

FIG. 4 shows a first flow of a data file writing method according to an embodiment of the invention;

FIG. 5 shows a second flow of a data file writing method according to an embodiment of the invention;

FIG. 6 shows a structure of a message file realized by a data file writing method according to an embodiment of the invention;

FIG. 7 shows a first structure of a data file writing system according to an embodiment of the invention;

FIG. 8 shows a second structure of a data file writing system according to an embodiment of the invention;

FIG. 9 shows a first flow of a data file reading method according to an embodiment of the invention;

FIG. 10 shows a second flow of a data file reading method according to an embodiment of the invention;

FIG. 11 shows a third flow of a data file reading method according to an embodiment of the invention;

FIG. 12 shows a fourth flow of a data file reading method according to an embodiment of the invention;

FIG. 13 shows a structure of a data file reading system according to an embodiment of the invention;

FIG. 14 shows a schematic block diagram of a computing device for performing a data file writing method and/or a data file reading method according to the invention; and

FIG. 15 shows a schematic storage unit for retaining or carrying a program code implementing a data file writing method and/or a data file reading method according to the invention.

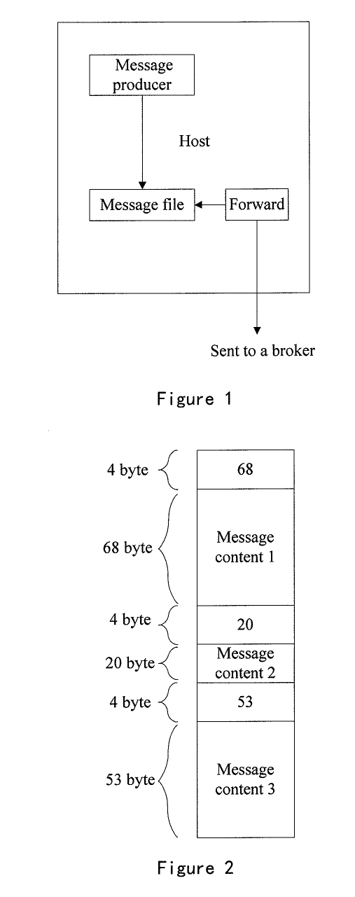

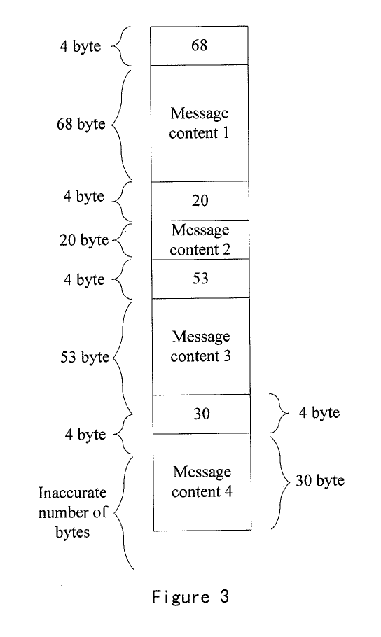

### DETAILED DESCRIPTION OF THE INVENTION

In the following the present invention will be further described in connection with the drawings and the particular embodiments.

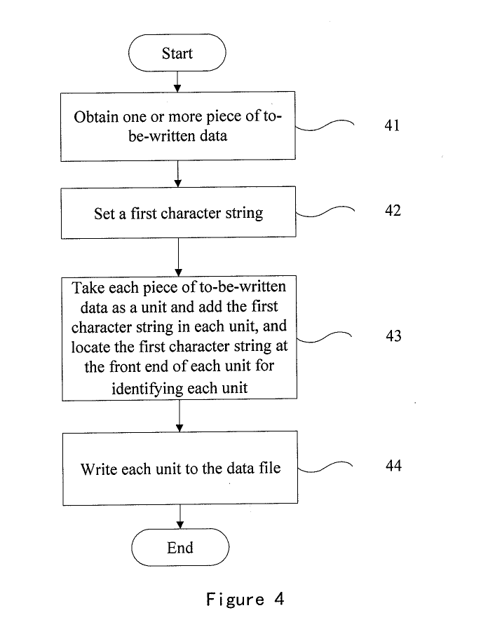

As shown in FIG. 4, an embodiment of the present invention provides a data file writing method for writing to-be-written data to a data file, comprising: step 41, obtaining one or more piece of to-be-written data; step 42, setting a first character string, of which the length and value can be designed flexibly, for example, 0x5e5c7cfe with a length of 4 bytes; step 43, taking each piece of to-be-written data as a unit and adding the first character string in each unit, and locating the first character string at the front end of each unit for identifying each unit, wherein the “unit” in this embodiment represents a combination of a first character string and to-be-written data, and may be embodied in different forms in different application scenarios, for example, in a message queue system, the to-be-written data is message content, the data file is a message file, a message producer adds a first character string in front of the message content to form a message, and each message is a unit; and step 44, writing each unit to the data file. In this embodiment, the first character string functions to identify each unit, thus ensuring that in a reading procedure, even if the data file is damaged, other unit can still be found by searching for the first character string, and if the found unit is not damaged, the data therein can be read correctly. In the scheme of this embodiment, only writing one file is involved, the written content becomes less, and writing a single file is easier, which benefits the improvement of the writing performance, and compared with increasing an index file, increasing a first character string is much easier, which also reduces the possibility of making errors. In this embodiment, the orders of the step 41 and the step 42 can be exchanged at will.

Another embodiment of the invention proposes a data file writing method. As compared to the above embodiment, in the data file writing method of this embodiment, the step 42 can be: extracting a plurality of characters from the one or more piece of to-be-written data to form the first character string. There are several principles of extraction, of which one is as follows: the plurality of characters are multiple characters with the lowest probabilities of occurrence in the one or more piece of to-be-written data, it means to avoid that the first character string is identical to a certain section of character string in the to-be-written data which will cause wrong recognition in a reading procedure. Taking the message queue system as an example, suppose that the length of the first character string is 4 bytes (of course, it may also be a length of other number of bytes), which can signify a number about 4 billion, and suppose that the length of each message is 100 bytes. Then, under a condition in which the message file is damaged, the probability that the first character string is consistent with a part of the content in a message is one per tens of millions, which is extremely low and can be ignored. It should be appreciated by those skilled in the art that there are a variety of principles of extraction, the above way of picking out characters with the lowest probabilities of occurrence is just an example, and does not limit the technical solution of this embodiment, and other principles are also feasible, for example, the plurality of characters are obtained randomly from the one or more piece of to-be-written data.

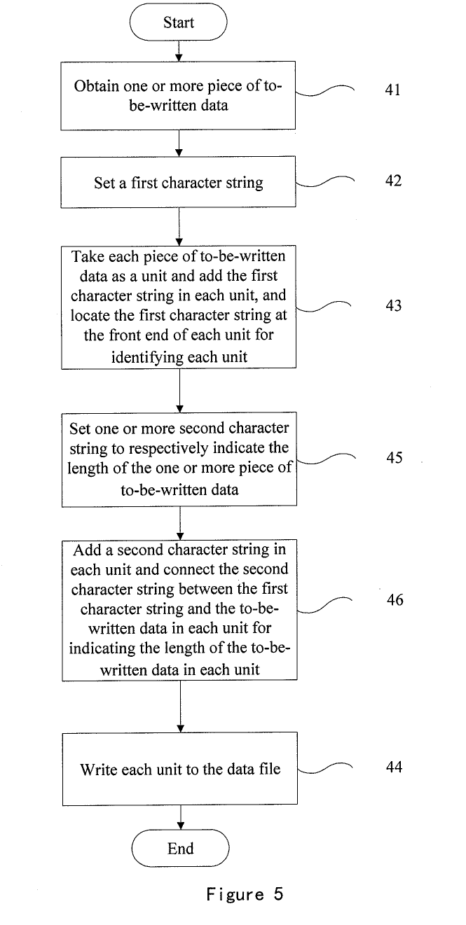

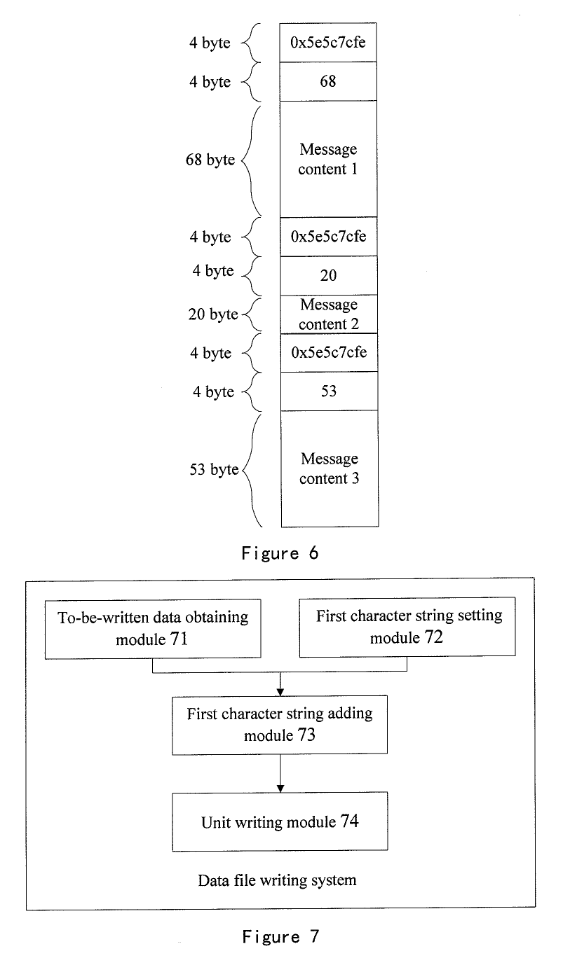

As shown in FIG. 5, another embodiment of the invention proposes a data file writing method. As compared to the above embodiments, in the data file writing method of this embodiment, before the step 44, there is further comprised: step 45, setting one or more second character string to respectively indicate the length of the one or more piece of to-be-written data; and step 46, adding a second character string in each unit and connecting the second character string between the first character string and the to-be-written data in each unit for indicating the length of the to-be-written data in each unit. In this embodiment, in a procedure of reading the data file, the data written to the data file can be read accurately according to the length indicated by the second character string. Taking the message queue system as an example, according to the technical solution of this embodiment, the format of the finally obtained message file (i.e., the data file) is as shown in FIG. 6, wherein in each message (i.e., each unit), there successively are the first character string of 4 bytes, which is 0x5e5c7cfe, the second character string of 4 bytes, which is 68, 20, 53, and the to-be-written data, which is the message content 1, the message content 2, and the message content 3. It should be appreciated by those skilled in the art that the above is just a kind of format of the unit, and it is simply an example, it does not limit the technical solution, and a format of other type is also applicable, for example, other information with a fixed length can be added between the second character string and the to-be-written data. In this embodiment, the orders of the step 41, the step 42 and the step 45 cab be exchanged at will, and the orders of the step 43 and the step 46 can be exchanged at will.

As shown in FIG. 7, an embodiment of the invention provides a data file writing system for writing to-be-written data to a data file, comprising: a to-be-written data obtaining module 71 configured to obtain one or more piece of to-be-written data; a first character string setting module 72 configured to set a first character string, of which the length and value can be designed flexibly, for example, 0x5e5c7cfe with a length of 4 bytes; a first character string adding module 73 configured to take each piece of to-be-written data as a unit and add the first character string in each unit, and locate the first character string at the front end of each unit for identifying each unit, wherein the “unit” in this embodiment represents a combination of a first character string and to-be-written data, and may be embodied in different forms in different application scenarios, for example, in a message queue system, the to-be-written data is message content, the data file is a message file, a message producer adds a first character string in front of the message content to form a message, and each message is a unit; and a unit writing module 74 configured to write each unit to the data file. In this embodiment, the first character string functions to identify each unit, thus ensuring that in a reading procedure, even if the data file is damaged, other unit can still be found by searching for the first character string, and if the found unit is not damaged, the data therein can be read correctly. In the scheme of this embodiment, only writing one file is involved, the written content becomes less, and writing a single file is easier, which benefits the improvement of the writing performance, and compared with increasing an index file, increasing a first character string is much easier, which also reduces the possibility of making errors.

Another embodiment of the invention proposes a data file writing system. As compared to the above embodiment, in the data file writing system of this embodiment, the first character string setting module 72 can extract a plurality of characters from the one or more piece of to-be-written data to form the first character string. There are several principles of extraction, of which one is as follows: the plurality of characters are multiple characters with the lowest probabilities of occurrence in the one or more piece of to-be-written data, it means to avoid that the first character string is identical to a certain section of character string in the to-be-written data which will cause wrong recognition in a reading procedure. Taking the message queue system as an example, suppose that the length of the first character string is 4 bytes (of course, it may also be other number of bytes), which can signify a number about 4 billion, and suppose that the length of each message is 100 bytes. Then, under a condition in which the message file is damaged, the probability that the first character string is consistent with a part of the content in a message is one per tens of millions, which is extremely low and may be ignored. It should be appreciated by those skilled in the art that there are a variety of principles of extraction, the above way of picking out characters with the lowest probabilities of occurrence is just an example, and does not limit the technical solution of this embodiment, and other principles are also feasible, for example, the plurality of characters are obtained randomly from the one or more piece of to-be-written data.

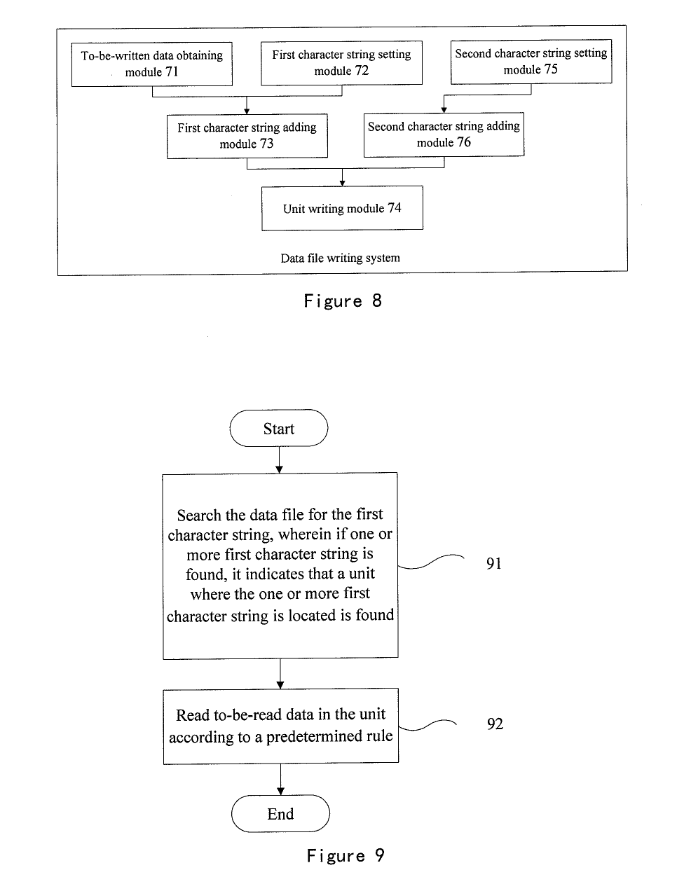

As shown in FIG. 8, another embodiment of the invention proposes a data file writing system. As compared to the above embodiments, the data file writing system of this embodiment may further comprise: a second character string setting module 75 configured to set one or more second character string to respectively indicate the length of the one or more piece of to-be-written data; and a second character string adding module 76 configured to add a second character string in each unit and connect the second character string between the first character string and the to-be-written data in each unit for indicating the length of the to-be-written data in each unit. In this embodiment, in a procedure of reading the data file, the data written to the data file can be read accurately according to the length indicated by the second character string. Taking the message queue system as an example, according to the technical solution of this embodiment, the format of the finally obtained message file (i.e., the data file) is as shown in FIG. 6, wherein in each message (i.e., each unit), there successively are the first character string of 4 bytes, which is 0x5e5c7cfe, the second character string of 4 bytes, which is 68, 20, 53, respectively, and the to-be-written data, which is the message content 1, the message content 2, and the message content 3, respectively. It should be appreciated by those skilled in the art that the above is just a kind of format of the unit, and it is simply an example, it does not limit the technical solution, and a format of other type is also applicable, for example, other information with a fixed length can be added between the second character string and the to-be-written data.

As shown in FIG. 9, an embodiment of the invention provides a data file reading method for reading to-be-read data from a data file, the data file comprises one or more unit, each unit has a first character string at the front end of each unit, each unit further has a piece of to-be-read data, and the method comprises: step 91, searching the data file for the first character string, for example, 0x5e5c7cfe of 4 bytes, wherein if one or more first character string is found, it indicates that a unit where the one or more first character string is located is found, wherein the “unit” in this embodiment represents a combination of a first character string and to-be-read data, and may be embodied in different forms in different application scenarios, for example, in a message queue system, when reading a message file (i.e., data file), one unit is one message, and the message content contained in the message is to-be-read data; and step 92, reading to-be-read data in the unit according to a predetermined rule. In this embodiment, the first character string functions to identify each unit, thus ensuring that in a reading procedure, even if the data file is damaged, other unit can still be found by searching for the first character string, and if the found unit is not damaged, the data therein can be read correctly. In the scheme of this embodiment, only reading one file is involved, the read content becomes less, and reading a single file is easier, which benefits the improvement of the reading performance.

Another embodiment of the invention proposes a data file reading method. As compared to the above embodiment, in the data file reading method of this embodiment, the step 91 can be: searching the data file for the first character string from front to back, and whenever a first character string is found, after reading of the to-be-read data in a unit where it is located is finished, continuing to search for a next first character string backwards from the to-be-read data, which means that the disk is read sequentially when reading the data file, and the efficiency is very high.

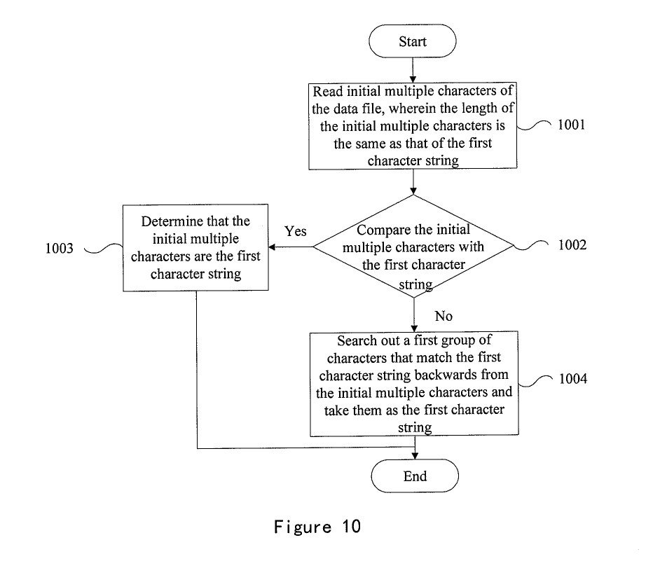

As shown in FIG. 10, another embodiment of the invention proposes a data file reading method. As compared to the above embodiments, in the data file reading method of this embodiment, the step 91 may comprise: step 1001, reading initial multiple characters of the data file, wherein the length of the initial multiple characters is the same as that of the first character string; step 1002, comparing the initial multiple characters with the first character string; step 1003, if the two match each other, determining that the initial multiple characters are the first character string; and step 1004, if the two do not match each other, searching out a first group of characters that match the first character string backwards from the initial multiple characters and taking them as the first character string. The whole procedure of this embodiment reads the disk sequentially, and the reading efficiency is very high. Taking the message queue system as an example, first, characters of 4 bytes are read and matched with the first character string 0x5e5c7cfe. If they are 0x5e5c7cfe, it indicates that these are the front end of a message (which is equivalent to a unit), and the content (i.e., to-be-read data) in the message is read according to the structure of the message. If they do not match, it is considered that damage occurs to the message file, then, the content that first matches the first character string is searched for backwards from the current position of the file and considered as the start of a next message, and then the message continues to be read.

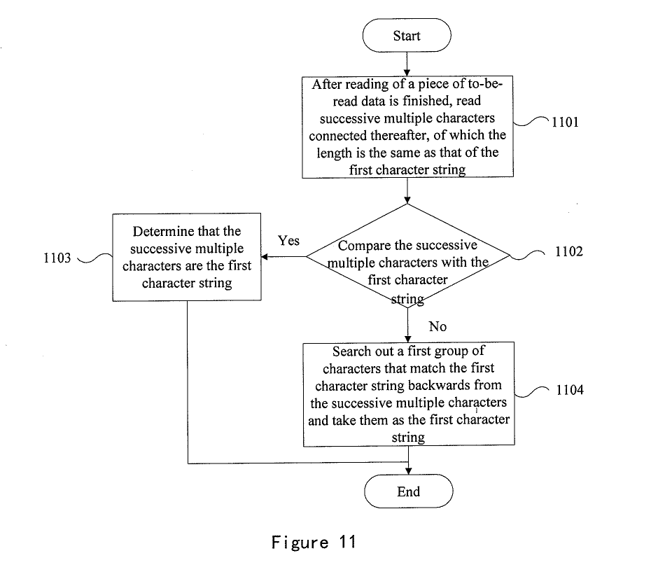

As shown in FIG. 11, another embodiment of the invention proposes a data file reading method. As compared to the above embodiments, in the data file reading method of this embodiment, the step 91 further comprises: step 1101, after reading of a piece of to-be-read data is finished, reading successive multiple characters connected thereafter, of which the length is the same as that of the first character string; step 1102, comparing the successive multiple characters with the first character string; step 1103, if the two match each other, determining that the successive multiple characters are the first character string; and step 1104, if the two do not match each other, searching out a first group of characters that match the first character string backwards from the successive multiple characters and taking them as the first character string. The whole procedure of this embodiment reads the disk sequentially, and the reading efficiency is very high. Take the message queue system as an example. After reading of the content of a message is finished, next, successive characters of 4 bytes are read and matched with the first character string 0x5e5c7cfe. If they are 0x5e5c7cfe, it indicates that these are the front end of a message (which is equivalent to a unit), and the content (i.e., to-be-read data) in the message is read according to the structure of the message. If they do not match, it is considered that damage occurs to the message file, then, the content that first matches the first character string is searched for backwards from the current position of the file and considered as the start of a next message, and then the message continues to be read.

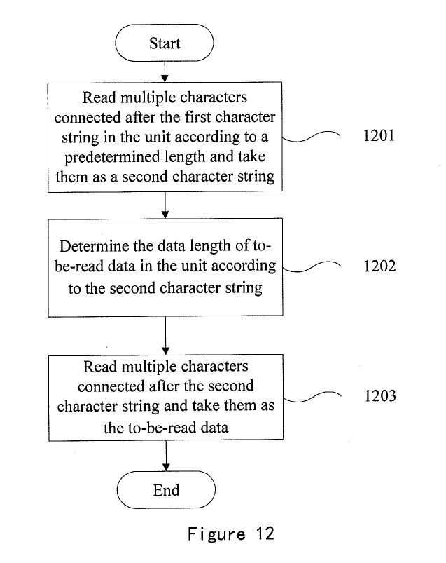

As shown in FIG. 12, another embodiment of the invention proposes a data file reading method. As compared to the above embodiments, in the data file reading method of this embodiment, the step 92 further comprises: step 1201, reading multiple characters connected after the first character string in the unit according to a predetermined length and taking them as a second character string; step 1202, determining the data length of to-be-read data in the unit according to the second character string; and step 1203, reading multiple characters connected after the second character string according to the data length and taking them as the to-be-read data. The scheme of this embodiment is implemented in a situation that a first character string, a second character string and to-be-read data are successively comprised in each unit of the data file. It should be appreciated by those skilled in the art that the specific way of reading to-be-read data depends on the structure of the data file. Take the message queue system as an example. If a first character string 0x5e5c7cfe is read, it indicates that this is the front end of a message, characters of 4 bytes are continuously read and taken as a second character string, the length of the message content is determined according to the value of the second character string, and assuming that the length is 68, characters of 68 bytes are continuously read and taken as the message content.

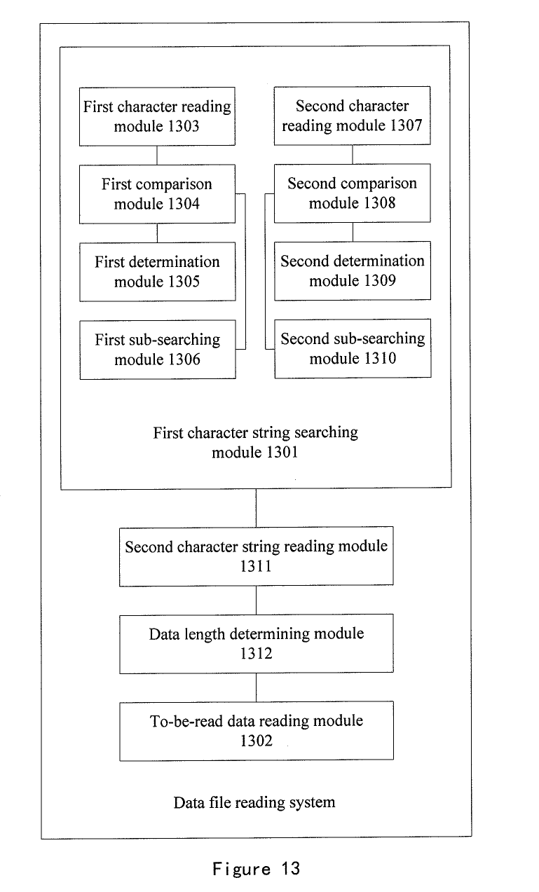

As shown in FIG. 13, an embodiment of the invention provides a data file reading system for reading to-be-read data from a data file, the data file comprises one or more unit, each unit has a first character string at the front end, each unit further has a piece of to-be-read data, and the system comprises: a first character string searching module 1301 configured to search the data file for the first character string, for example, 0x5e5c7cfe of 4 bytes, wherein if one or more first character string is found, it indicates that a unit where the one or more first character string is located is found, wherein the “unit” in this embodiment represents a combination of a first character string and to-be-read data, and may be embodied in different forms in different application scenarios, for example, in a message queue system, when reading a message file (i.e., data file), one unit is one message, and the message content contained in the message is to-be-read data; and a to-be-read data reading module 1302 configured to read to-be-read data in the unit according to a predetermined rule. In this embodiment, the first character string functions to identify each unit, thus ensuring that in a reading procedure, even if the data file is damaged, other unit can still be found by searching for the first character string, and if the found unit is not damaged, the data therein can be read correctly. In the scheme of this embodiment, only reading one file is involved, the read content becomes less, and reading a single file is easier, which benefits the improvement of the reading performance.

Another embodiment of the invention proposes a data file reading system. As compared to the above embodiment, in the data file reading system of this embodiment, the first character string searching module 1301 can search the data file for the first character string from front to back, and whenever a first character string is found, after reading of the to-be-read data in a unit where it is located is finished, continue to search for a next first character string backwards from the to-be-read data, which means that the disk is read sequentially when reading the data file, and the efficiency is very high.

Another embodiment of the invention proposes a data file reading system. As compared to the above embodiments, in the data file reading system of this embodiment, the first character string searching module 1301 may comprise: a first character reading module 1303 configured to read initial multiple characters of the data file, wherein the length of the initial multiple characters is the same as that of the first character string; a first comparison module 1304 configured to compare the initial multiple characters with the first character string; a first determination module 1305 configured to, if the two match each other, determine that the initial multiple characters are the first character string; and a first sub-searching module 1306 configured to, if the two do not match each other, search out a first group of characters that match the first character string backwards from the initial multiple characters and take them as the first character string. The whole procedure of this embodiment reads the disk sequentially, and the reading efficiency is very high. Taking the message queue system as an example, first, characters of 4 bytes are read and matched with the first character string 0x5e5c7cfe. If they are 0x5e5c7cfe, it indicates that these are the front end of a message (which is equivalent to a unit), and the content (i.e., to-be-read data) in the message is read according to the structure of the message. If they do not match, it is considered that damage occurs to the message file, then, the content that first matches the first character string is searched for backwards from the current position of the file and considered as the start of a next message, and then the message continues to be read.

Another embodiment of the invention proposes a data file reading system. As compared to the above embodiments, in the data file reading system of this embodiment, the first character string searching module 1301 may further comprise: a second character reading module 1307 configured to, after reading of a piece of to-be-read data is finished, read successive multiple characters connected thereafter, of which the length is the same as that of the first character string; a second comparison module 1308 configured to compare the successive multiple characters with the first character string; a second determination module 1309 configured to, if the two match each other, determine that the successive multiple characters are the first character string; and a second sub-searching module 1310 configured to, if the two do not match each other, search out a first group of characters that match the first character string backwards from the successive multiple characters and take them as the first character string. The whole procedure of this embodiment reads the disk sequentially, and the reading efficiency is very high. Take the message queue system as an example. After reading of the content of a message is finished, next, successive characters of 4 bytes are read and matched with the first character string 0x5e5c7cfe. If they are 0x5e5c7cfe, it means that these are the front end of a message (which is equivalent to a unit), and the content (i.e., to-be-read data) in the message is read according to the structure of the message. If they do not match, it is considered that damage occurs to the message file, then, the content that first matches the first character string is searched for backwards from the current position of the file and considered as the start of a next message, and then the message continues to be read.

Another embodiment of the invention proposes a data file reading system. As compared to the above embodiments, the data file reading system of this embodiment, may further comprise: a second character string reading module 1311 configured to read multiple characters connected after the first character string in the unit according to a predetermined length and take them as a second character string; a data length determining module 1312 configured to determine the data length of to-be-read data in the unit according to the second character string; and a to-be-read data reading module 1302 configured to read multiple characters connected after the second character string according to the data length and take them as the to-be-read data. The scheme of this embodiment is implemented in a situation that a first character string, a second character string and to-be-read data are successively comprised in each unit of the data file. It should be appreciated by those skilled in the art that the specific way of reading to-be-read data depends on the structure of the data file. Take the message queue system as an example. If a first character string 0x5e5c7cfe is read, it means that this is the front end of a message, characters of 4 bytes are continuously and taken as a second character string, the length of the message content is determined according to the value of the second character string, and assuming that the length is 68, characters of 68 bytes are continuously read and taken as the message content.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a data file writing system and a data file reading system according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

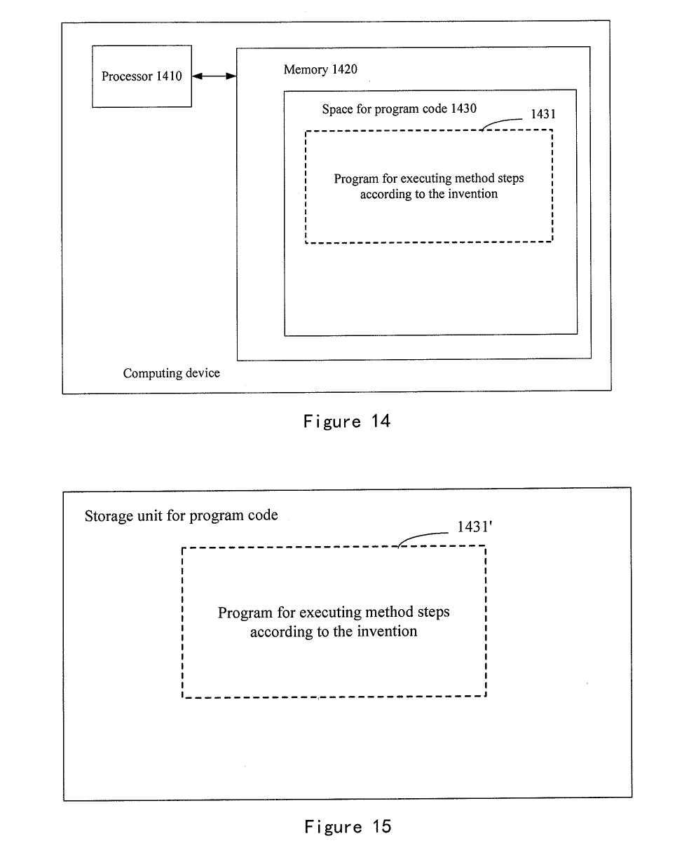

For example, FIG. 14 shows a computing device which may carry out a data file writing method and a data file reading method according to the invention. The computing device traditionally comprises a processor 1410 and a computer program product or a computer readable medium in the form of a memory 1420. The memory 1420 may be an electronic memory such as a flash memory, an EEPROM (electrically erasable programmable read-only memory), an EPROM, a hard disk or a ROM. The memory 1420 has a memory space 1430 for a program code 1431 for carrying out any method steps in the methods as described above. For example, the memory space 1430 for a program code may comprise individual program codes 1431 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 15. The storage unit may have a memory segment, a memory space, etc. arranged similarly to the memory 1420 in the computing device of FIG. 14. The program code may for example be compressed in an appropriate form. In general, the storage unit comprises a computer readable code 1431′, i.e., a code which may be read by e.g., a processor such as 1410, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A data file writing method for writing to-be-written data to a data file, comprising:
obtaining one or more piece of to-be-written data;
setting a first character string;
taking each piece of to-be-written data as a unit and adding the first character string in each unit, and locating the first character string at the front end of each unit for identifying each unit; and
writing each unit to the data file.

2. The data file writing method as claimed in claim 1, wherein the step of setting a first character string comprises:
extracting a plurality of characters from the one or more piece of to-be-written data to form the first character string.

3. The data file writing method as claimed in claim 2, wherein
the plurality of characters are multiple characters with the lowest probabilities of occurrence in the one or more piece of to-be-written data.

4. The data file writing method as claimed in claim 1, wherein before the step of writing each unit to the data file, there is further comprised:
setting one or more second character string to respectively indicate the length of the one or more piece of to-be-written data; and
adding a second character string in each unit and connecting the second character string between the first character string and the to-be-written data in each unit for indicating the length of the to-be-written data in each unit.

5.-8. (canceled)

9. A data file reading method for reading to-be-read data from a data file, the data file comprising one or more unit, each unit having a first character string at the front end, each unit further having a piece of to-be-read data, and the method comprising:
searching the data file for the first character string, wherein if one or more first character string is found, it indicates that a unit where the one or more first character string is located is found; and
reading to-be-read data in the unit according to a predetermined rule.

10. The data file reading method as claimed in claim 9, wherein the step of searching the data file for the first character string comprises:
searching the data file for the first character string from front to back, and whenever a first character string is found, after reading of the to-be-read data in a unit where it is located is finished, continuing to search for a next first character string backwards from the to-be-read data.

11. The data file reading method as claimed in claim 10, wherein the step of searching the data file for the first character string comprises:
reading initial multiple characters of the data file, wherein the length of the initial multiple characters is the same as that of the first character string;
comparing the initial multiple characters with the first character string;
if the two match each other, determining that the initial multiple characters are the first character string; and
if the two do not match each other, searching out a first group of characters that match the first character string backwards from the initial multiple characters and taking them as the first character string.

12. The data file reading method as claimed in claim 10, wherein the step of searching the data file for the first character string further comprises:
after reading of a piece of to-be-read data is finished, reading successive multiple characters connected thereafter, of which the length is the same as that of the first character string;
comparing the successive multiple characters with the first character string;
if the two match each other, determining that the successive multiple characters are the first character string; and
if the two do not match each other, searching out a first group of characters that match the first character string backwards from the successive multiple characters and taking them as the first character string.

13. The data file reading method as claimed in claim 9, wherein the step of reading to-be-read data in the unit according to a predetermined rule comprises:
reading multiple characters connected after the first character string in the unit according to a predetermined length and taking them as a second character string;
determining the data length of to-be-read data in the unit according to the second character string; and
reading multiple characters connected after the second character string according to the data length and taking them as the to-be-read data.

14.-19. (canceled)

20. A non-transitory computer readable medium having instructions stored thereon that, when executed by at least one processor, cause the at least one processor to perform following operations:
obtaining one or more piece of to-be-written data;
setting a first character string;
taking each piece of to-be-written data as a unit and adding the first character string in each unit, and locating the first character string at the front end of each unit for identifying each unit;
writing each unit to the data file;
searching the data file for the first character string, wherein if one or more first character string is found, it indicates that a unit where the one or more first character string is located is found; and
reading to-be-read data in the unit according to a predetermined rule.
